(19) United States
(12) Patent Application Publication
(10) Pub. No.: US 2015/0287097 A1
(43) Pub. Date: Oct. 8, 2015

(54) Advertisement Control Platform For Managing Viewability-Based Advertising Campaigns And Bids

(71) Applicant: Dennoo Inc., Palo Alto, CA (US)

(72) Inventor: Shigeto Umeda, Palo Alto, CA (US)

(21) Appl. No.: 14/677,925

(22) Filed: Apr. 2, 2015

Related U.S. Application Data
(60) Provisional application No. 61/974,260, filed on Apr. 2, 2014.

(51) Int. Cl. G06Q 30/02

(52) U.S. Cl. CPC G06Q 30/0275

(57) ABSTRACT

An advertisement (ad) control platform for managing advertising campaigns and bids for advertising opportunities. The ad control platform equips ads to be submitted in response to the advertising opportunities with capabilities to perform measurements related to viewable time of the ads when the ads are published. It analyzes properties of ads published as a result of winning bids in terms of viewable time based on the performed measurements. It allows an advertiser to set up an advertising campaign with various goals, including those related to viewable time. Based on the analysis result and the campaign goals, it determines a bidding price for the campaign expressed in terms of viewable time. In response to an advertising opportunity, it converts the determined bidding price into one expressed in terms of a number of impressions and submits a bid including the converted bidding price and associated ads each equipped with the aforementioned capabilities.

### CROSS-REFERENCE TO RELATED APPLICATION

The present application claims priority to and benefit from U.S. Provisional Patent Application No. 61/974,260 filed on Apr. 2, 2014, and titled “Advertisement Control Platform For Managing Viewability-Based Advertising Campaigns And Bids,” the entire content of which is herein expressly incorporated by reference.

### RELATED APPLICATIONS

The present application is related to International Application No. PCT/US2012/054507, filed Sep. 10, 2012, entitled “Methods And Systems For Bidding And Acquiring Advertisement Impressions,” and U.S. Provisional Patent Application No. 61/785,765, filed Mar. 14, 2013, entitled “Systems And Methods For Implementing An Advertisement Platform With Novel Cost Models,” the entire contents of each of which are herein expressly incorporated by reference.

### FIELD OF THE INVENTION

Various embodiments of the present invention generally relate to calculating advertisement (ad) viewable time and bidding for ad publication opportunities. More specifically, the various embodiments relate to analyzing data related to ad viewable time from past bids to determine future bidding prices.

### BACKGROUND OF THE INVENTION

In today's digital world, ads are published not only in printed publications but also in digital media. As the reach of digital media can be very broad, it is beneficial for advertisers to publish their ads in digital media. Therefore, competition to win advertising opportunities in digital media can be fierce. Furthermore, the nature of digital media, which accommodates the use of computer software, makes it possible to display ads in complex ways. For example, the same spot in a page of a publication can be filled with different ads in different displays of the page depending on the audience of each display.

As a result, there are ad exchange markets where advertisers submit bids for advertising opportunities posted by media publishers in real time. For each advertising opportunity, an advertiser needs to take various factors into consideration in determining bidding prices. For example, on the one hand, the advertiser may want to ensure that its ad receives enough viewing among a specific population during a specific timeframe. On the other hand, the advertiser may have only a certain budget available. Therefore, advertisers would benefit from techniques which help them make intelligent decisions on bidding prices.

### SUMMARY OF THE INVENTION

According to some embodiments, an advertisement control platform connected to an advertisement exchange market, where publishers supply publication opportunities and advertisers bid for the publication opportunities, performs the following method. It embeds a computer program in an advertisement which produces data related to viewable time of the advertisement when the advertisement is published as a result of winning a bid in the advertisement exchange market. It analyzes characteristics of advertisements published as a result of winning a bid with respect to viewable time based on data produced by the computer program for each of the advertisements. In addition, it sets up an advertising campaign associated with one or more advertisements based on input from an advertiser, wherein the advertising campaign has goals including a minimum amount of viewable time for an advertisement, a budget, a target audience, and a timeframe. It also determines a bidding price expressed in terms of viewable time for the advertising campaign based on the goals of the advertising campaign and the analysis result, and converts the determined bidding price to a bidding price expressed in terms of impressions. Subsequently, it submits a bid including the converted bidding price and the one or more advertisements, with the computer program embedded in each of the one or more advertisements, to the advertisement exchange market in response to a publication opportunity.

### BRIEF DESCRIPTION OF THE DRAWINGS

The above and other features, aspects and advantages of various embodiments will become better understood with regard to the following description, appended claims, and accompanying drawings.

FIG. 1 is a diagram illustrating an example environment in which an advertising control platform discussed in various embodiments may operate.

FIG. 2 is a block diagram illustrating example components of the advertising control platform.

FIGS. 3A-3C are user interface diagrams illustrating example user interfaces for setting up an advertising campaign.

FIG. 4 is a diagram illustrating an example process performed by the advertising control platform.

FIG. 5 contains a high-level block diagram showing an example architecture of a computer, which may represent any electronic device, any server, or any node within a cloud service as described herein.

### DETAILED DESCRIPTION

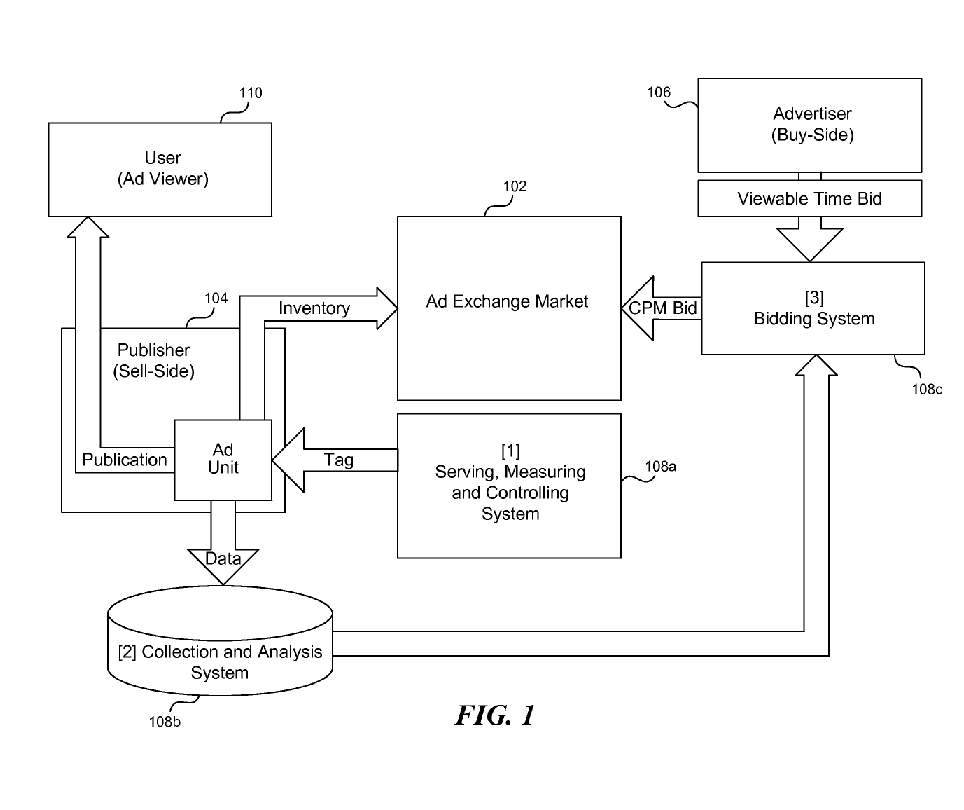

FIG. 1 is a diagram illustrating an example environment in which an advertising control platform discussed in various embodiments may operate. In this environment, an ad exchange market 102 offers a bidding marketplace where publishers 104 post advertising opportunities and advertisers 106 bid for the advertising opportunities. For example, a typical bidding process may start when a user 110 accesses a webpage of a publisher 104 which includes a spot for rendering an ad that would be substantially visible to the user 110. The publisher 104 may then send an opportunity associated with the spot to the ad exchange market 102 and request that advertisers 106 place bids in terms of the number of impressions for the opportunity. In response to the bid request, the advertisers 106 submit bids along with ads to be served in the spot. After receiving the bids from the advertisers 106, the publisher 104 determines a winning bid based on predefined criteria and notifies the advertisers 106 regarding the winning price. Furthermore, the ad of the winning advertiser is served in the spot.

The advertisers 106 generally have various goals, including short-term and long-term objectives, such as generating revenue, establishing a brand image, gaining visibility, and so on. The advertising control platform 108 assists advertisers 106 in placing winning bids that fulfill their various goals. It comprises three components 108A-C that work with advertisers 106 and the ad exchange market 102, to understand the decision-making processes of the publishers 104 in accepting bids and the bidding dynamic controlled by the ad exchange market 102, and ultimately submit winning bids for the advertisers 106.

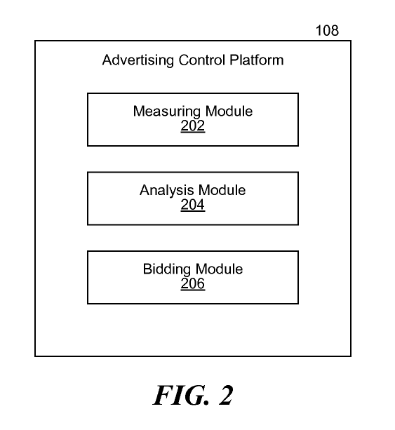

FIG. 2 is a block diagram illustrating example components of the advertising control platform 108. The advertising control platform 108 may comprise a measuring module 202, an analysis module 204, and a bidding module 206, which respectively correspond to the three components 108A-C illustrated in FIG. 1. The measuring module 202 may equip ads to be submitted to publishers with measuring capabilities, which in turn may measure viewability of the ads when the ads are published. The analysis module 204 may analyze properties of winning bids, including viewing and pricing metrics, based on the output of the measuring module 202. The bidding module 206 may determine bidding prices for advertising opportunities based on the output of the analysis module 204.

In some embodiments, the measuring modules 202 may embed a tag, namely a computer program, in each digital ad submitted to a publisher. The tag is generally invisible, but it would measure the viewable time of the ad when it is published or served. Here, the “viewable time” refers to the number of seconds that a served ad has been physically visible or “viewable” on a user's screen in terms of a specific area percentage, such as 50% for desktop ads and 10% for mobile ads. Scenarios in which the ad is not viewable include but are not limited to: when the user has scrolled the screen and more than half of the ad is hidden, when the window in which the ad can be displayed has been minimized, when another tab has been opened in the browser so that the tab in which the ad can be displayed is no longer visible, and when the browser's window is not the active window in focus.

In some embodiments, the measuring module 202 may also ensure that each digital ad and specifically video ad sent to a publisher is capable of controlling the video based on the state of viewability. For example, when the ad is not viewable, the video may be paused automatically, and when the ad is viewable again, the ad resumes.

A tag can implement one or more of a number of known methods. A first example is the geometric method, in which the distance that a user has scrolled on a publisher's property (e.g., webpage) is measured, and the ad's viewability is determined from the ad's positioning and the user's scrolling behavior. A second example is the load rate method. When ads are rendered on a user's screen, there is a difference in the load that is caused by a viewable ad and an ad that is not viewable. In the load rate method, the difference is identified and whether the ad is viewable or not is determined. A third example is the first party tag method. Ads can be served into inline frames or “iframes”, which are pages that are rendered inside another page. When tags are also served inside iframes of a publisher's webpage, the publisher's security settings may interfere with the measurement of viewability. In the first party tag method, first party tags are served or placed directly into the publisher's webpage, and the security limitations may be evaded. A fourth example measures the owned media viewable time, which is the effective amount of time a user spent on the landing site of an advertiser to which the user is redirected upon clicking on the advertiser's ad. The viewable time is measured when any portion of the landing site is visible in the web browser and the browser tab showing that portion is in focus and attracting a user action.

From the tags, the measuring module 202 may obtain viewability information, such as the amount of time an ad is placed in an ad spot, the amount of time the ad is considered visible and thus viewable while it is in the ad spot, etc. A tag may also be used to collect additional information from a user's computer. For example, it may analyze the cookies stored on the user's computer to infer the user's demographic information and interests. Therefore, the measuring module 202 may ultimately produce viewability data as well as any other types of data as output, which may be used by the analysis module 204.

In some embodiments, the analysis module 204 may analyze characteristics of the ads submitted to and published by the publishers, including pricing metrics. One pricing metric is the price per unit of viewable time, or Cost per Second (CPS). The cost charged to the advertiser is based on the actual display time of an ad. Another pricing metric is the cost per amount of viewable time that is above a threshold within a duration, or Cost per View (CPV). An example is having an ad viewed for more than 10 seconds within an hour. The threshold and the duration may be pre-selected by an advertiser. An advertiser is charged only when their ad acquires more viewable time than the threshold during each duration. Therefore, if the ad is not delivered for more than the threshold, the advertiser incurs no cost for any delivery that takes place. On the other hand, a pricing metric that is not related to viewable time is the price per one thousand impressions, or Cost per Millie (CPM). An online ad impression is a single appearance of an ad on a webpage. Each time an ad loads onto a user's screen, the ad server may count that loading as one impression. For an ad exchange market, CPM is often the preferred pricing metric.

For example, the analysis module 204 may infer whether a view (visibility of an ad for at least a certain amount of time) may be obtained when an ad is displayed to a user by applying supervised learning to submitted ads published by the publishers. Whether a view happened or not is a binary classification, and thus a probability value can be calculated by learning through the support vector machine using logistic regression. Because viewable time is a consecutive value, the number of seconds may be inferred by regression analysis. The calculated probability will be referred to as pᵥₜ below. For the inference of pᵥₜ, interest matching (i.e., matching based on user information and ad property) can be included if needed.

In some embodiments, in addition to receiving ad data and user data from the measuring module 202, the analysis module 204 may obtain user data from third-party collectors, which would generally be of an aggregate nature. Based on all the data available, the analysis module 204 may analyze the distributions of the pricing metrics over all the submitted ads. It may further classify such data with respect to attributes of the publishers, users (members of ad audience), ads, etc. As one example, it may compute the average CPM for a food company publisher over all the submitted ads published by this publisher that concern pastas. As another example, it may compute the minimum and maximum CPV over all the submitted and published ads that appeal to audience members in particular age groups and geographic regions. When the bidding prices are expressed in terms of CPMs, conversion from CPM to viewability-based pricing metrics may be necessary, as discussed in detail below. Additional examples involving one or more ad spots include the following:
1) Average CPM during a period T
2) Average viewable time from each impression during the period T
3) Average number of seconds for which each advertiser in the period T had an advertising strategy (e.g. the length of the video uploaded, the length of banner impression specified)
4) Relationship between bid values and probabilities of winning
5) Distribution of CPV values for each view threshold

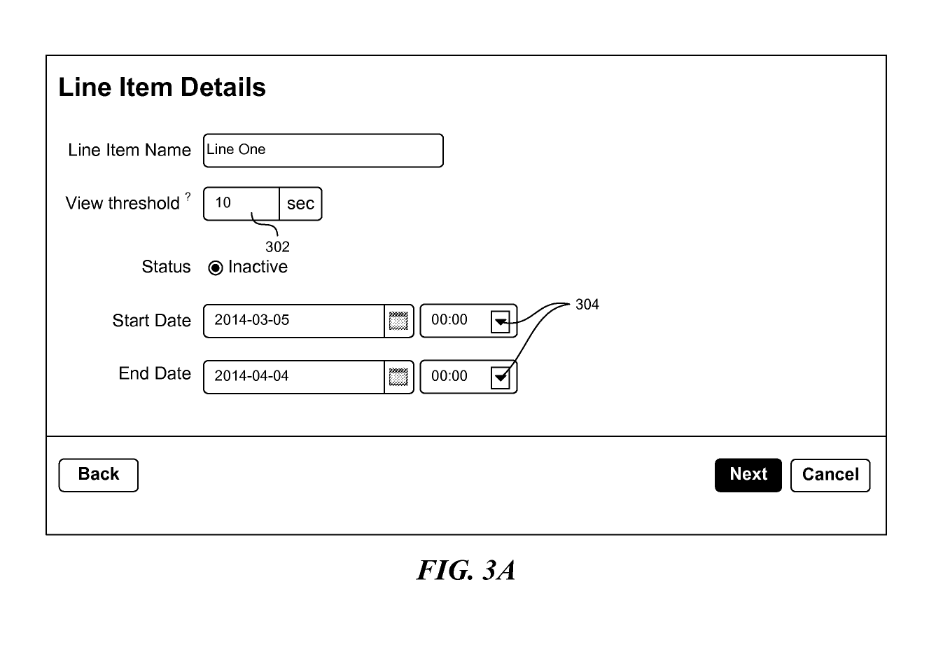

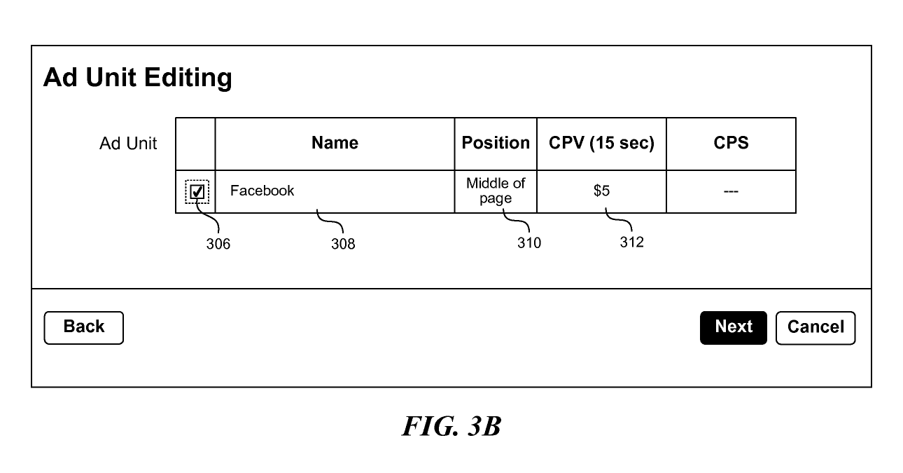

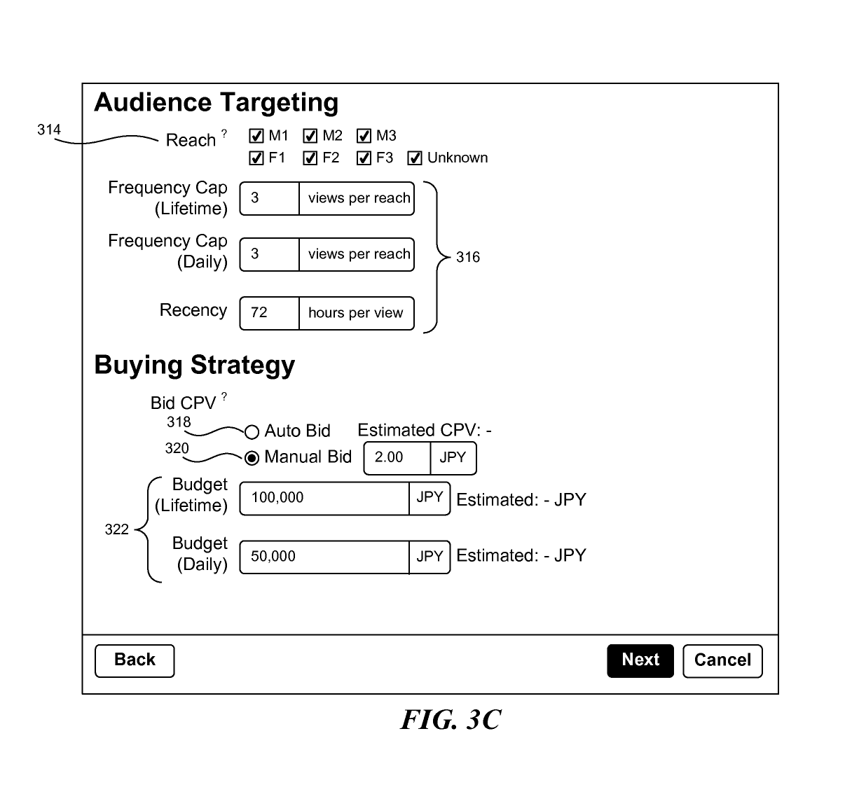

In some embodiments, the bidding module 206 may allow an advertiser to set up an advertising campaign for spending a certain amount of money for one or more ads on one or more advertising opportunities within a specific timeframe. FIGS. 3A-3C are user interface diagrams illustrating examples of user interfaces for setting up an advertising campaign. With a user interface illustrated in FIG. 3A, an advertiser may specify a desired threshold on viewable time for the advertiser's ads via 302. The advertiser may also specify a campaign timeframe in which the ads should be run via 304. With a user interface illustrated in FIG. 3B, the advertiser may select one or more types of advertising opportunities for which to place bids for the ads via 306. Information about a type of advertising opportunity offered by a publisher, which may be a display in a spot of a webpage on the publisher's website, may include the name of the publisher in 306, the position of the spot on the webpage in 308, and the minimum bidding price in terms of CPV, which is normally converted from a bidding price in terms of CPM, as discussed in detail below.

With a user interface illustrated in FIG. 3C, the advertiser may indicate the types of audiences to whom the ads are to be displayed via 312. For example, M1-M3 and F1-F3 respectively represent different male and female groups defined by specific attributes. For the indicated types of audiences, the advertiser may also specify a frequency cap indicating a maximum number of times to display the ads for each of a few durations via 314. Furthermore, the advertiser may indicate a buying strategy, including a bidding price and a bidding budget. The advertiser may choose the “manual bid” option via 318 and specify a bidding price. The advertiser may also choose the “auto bid” option via 320, in which case the bidding module 206 would determine the bidding price, as discussed in detail below. In addition, the advertiser may set the bidding budgets over specific durations via 322.

As a result, during the campaign timeframe, the bidding module 206 would keep placing bids for the selected types of advertising opportunities which would accommodate the ads and reach the targeted types of audience, subject to the constraints of the frequency caps and the bidding budgets. Normally, it would submit bids for the lowest determined bidding prices, but it may automatically adjust bidding prices in order to meet the demands of the ad exchange market.

In some embodiments, the bidding module 206 may determine a bidding price for an advertising campaign based on the campaign goals and the output of the analysis module 204. It may determine the bidding price at predetermined times or whenever a new advertising opportunity becomes available to tailor the bidding price to the advertising opportunity. The following discussion illustrates one method of determining a bidding price in terms of viewable time. For a digital medium Mᵢ and a spot F_{i,j} on the medium, 1,000×p_{i,j} defined as the average price during a period T for buying a thousand single impression (CPM) of the spot F_{i,j} can be part of the output of the analysis module 204. In addition, AVT_{i,j} defined as the average viewable time from each impression of the spot F_{i,j} during time T, can be part of the output of the analysis module 204. This value is the number of seconds of ad impression of F_{i,j} that can be bought or obtained with p_{i,j}. Furthermore, wAAL_{i,j,k,l} defined as the average number of seconds for which an advertiser Advₖ in the period T had an advertising strategy for the spot F_{i,j} can be part of the output of the analysis module 204. Accordingly, the cost-per-second of strategic time (time for which advertisers had an advertising strategy) can be computed as

$${cps}_{i , j} = \frac{{p}_{i , j}}{{wAAL}_{i , j , k , l}} .$$

Conventionally, the advertiser Advₖ might pay p_{i,j} to buy the spot F_{i,j} and end up showing AL_{k,l} seconds of their ad, while the advertiser only had a strategy for the AIT_{k,l} seconds, so the remaining (AIT_{i,j}-AL_{k,l}) seconds would not be not utilized when the billing is done in terms of CPM. Since the bidding module 206 may supply more than one advertiser per page view to achieve a total showing time of AITᵢⱼ, however, AL_{k,l} seconds of the spot F_{i,j} can be sold to the advertiser Advₖ. Accordingly, the suggested bid value for the advertiser Advₖ is bid_{suggested}=cps_{i,j}×AL_{k,l}.

The following discussion illustrates a second method of determining a bidding price in terms of viewable time. The determination is posed as an optimization problem of gaining as many views as possible for the lowest cost possible. A machine learning approach may be used for the optimization. The support vector machine may be used for the classifier and the support vector regression may be used for the regression analysis, but the optimization method explained below is general and other machine learning approaches may also be used in the same manner.

It can be expected that three elements would be necessary for the bidding strategy. The first element is when a given ad a is displayed in a given ad unit b, the probability P VT(a, b) that a viewable display VT is accomplished for a specified viewable time t. The second element is the possibility of winning a bid. The third element is adjustment based on constraints such as the timeframe and budget of the campaign.

With the first element, the value v that ad unit would have for the given ad a of a given advertiser can be inferred. However, an ad exchange market is a competitive bidding system. In order to make a decision on the appropriate bidding price, there must be a strategy for the winning bid price. Obviously, the lower the winning bid price the better in terms of an advertiser's profit, but bidding at low prices would bring the chances of winning down as well. In real campaigns, advertisers have a budget B to use during a given a period T.

For a given advertising unit, the predicted probability of a view is p_vt. Because the probability of a view is the value of that advertising unit, the larger the p_vt, the bid value val will also be set at a larger value in order to increase the probability of winning. One method of calculation is to set b proportional to p_vt. Another approach infers the relationship between the bid value and the probability of winning for each advertising unit, and determines the bid value so that p_vt would be proportional to the probability of winning. However, it is cumbersome to infer the relationship between the bid value and the probability of winning for each and every advertising unit.

Another approach calculates the relationship between the bid value and the probability of winning based on the output of the analysis module 204 for each advertising unit, and uses this to calculate the appropriate increase in the bid value. In other words, val=c f(p_vt) can be written as p_o (b)∝p_vt, where f is a function and p_o is the probability of winning the bid. A bid value where many users' bids may concentrate plus a small increase may lead to a higher probability of winning, but when the increase reaches a certain level, it can be expected that increases in bid price would not increase the probability of winning much anymore. The coefficient c is the parameter to determine the overall price, so by setting the price for the campaign, the coefficient would be set for the entire campaign. An appropriate value for this coefficient would fluctuate based on the market and the campaign's situation, and therefore will be inferred using recent statistical data, as discussed in detail below.

When in use, multiple campaigns will run simultaneously. Therefore, it is necessary to determine which campaign the bid for a specific advertising unit is for. For campaign selection, the one with the highest value may become the basis. A higher p_vt may have a higher value. At the same time, for the purpose of the system's profit, a campaign with a higher price c would be prioritized. In other words, the campaign with the highest c p_vt may be chosen. For campaigns with the same view threshold setting, the one with the highest price may be chosen if there is no interest matching involved. If interest matching is involved, p would naturally fluctuate and therefore it would not be a selection based on the highest price.

The advertiser's campaign conditions are the campaign period and the total number of views within that campaign period. An example of such condition would be to have 10,000 views in a month. As mentioned previously, determining the c for val=c f(p_a) is equivalent to determining the total budget necessary to meet the campaign goals and conditions. Determining this c is to determine a common “market value” for an entire bidding system. If the number of advertising units were infinite, the necessary number of advertising units might always be obtained. However, when in use, the bidding is a competition within a given campaign period, and the market value is decided based both on the publishers' market conditions and the advertisers' market conditions in terms of the campaigns that are registered in the bidding system. The market's optimal value c is a value that would optimize the CPV of all campaigns. For this optimization, a statistical approach would be used if there is abundant data. However, because it can be expected that the amount of data would not suffice, bids can be placed with a random c for sampling, and an optimal value can be obtained from these results. The probability of fulfilling conditions when c is determined can be calculated from the output of the analysis module 204. For example, past CPV can be calculated for each view threshold, and when this is applied to campaigns for each view threshold, the approximate CPV can be calculated. This will be used for suggested bid.

In some embodiments, the bidding module 206 may convert a manually specified bidding price in CPV to a bidding price in CPM for submission to an ad exchange market. It may also convert an automatically determined bidding price in CPM to a bidding price in CPV for display to the user. The following discussion illustrates one method of performing the CPV to CPM (and vice-versa) translation. Let “T” denote the amount of viewable time guaranteed in CPV model for a given ad. For the impression (used to display the ad) being auctioned, gather data associated with the impression, as can be done by the measuring module 202 and analysis module 204. For example, for the impression associated with a top banner ad slot in webpage www.nytimes.com, the impression represents a specific opportunity for a buyer to display their ad in the top banner ad slot in www.nytimes.com. The gathered data associated with the impression can include the number of impressions “N” generated for the ad slot over a given period of time (e.g., one day, one week, or one month), the number of those impressions that achieved a viewable time greater than T (“N_{T}”) during the same given period of time, etc. CPV can then be translated into an equivalent CPM value or vice-versa via the equation

$$CPV = \frac{CPM}{1000} \cdot \frac{N}{{N}_{T}} .$$

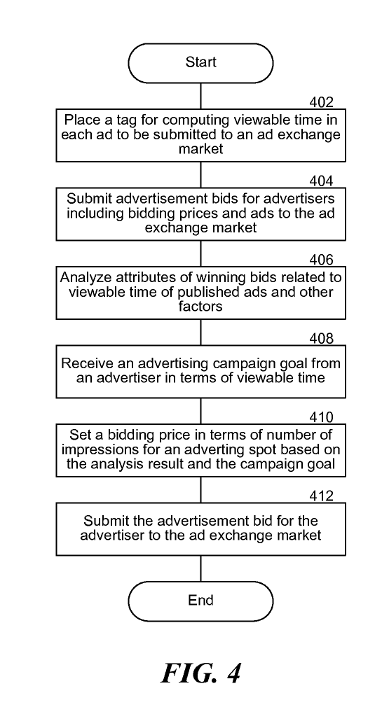

FIG. 4 is a diagram illustrating an example process performed by the advertising control platform 108. At block 402, the advertising control platform 108 inserts a tag to perform various measurements, including viewability, in each ad to be submitted to an ad exchange market. At block 404, it submits bids to the ad exchange market, where each bid includes a bidding price, typically in terms of CPM, and one or more ads each with an embedded tag. Generally, it submits one or more bids in response to the posting of advertising opportunities in the ad exchange market in real time. As one or more of the submitted bids are selected by the publishers as winning bids, the corresponding ads would be published, and the corresponding tags would perform various measurements. At block 406, the advertising control platform 108 analyzes the measurements to extract insight from past data. While the measurements may generally be related to viewable time, the bidding prices are generally related to the number of impressions. Therefore, the advertising control platform 108 may perform conversions from CPM to CPV or CPS, for example, as necessary. At block 408, the advertising control platform 108 allows a specific advertiser to specify campaign goals, including a minimum duration for which each ad created by the specific advertiser will preferably be viewed in each placement in an ad spot. At block 410, equipped with all the insight obtained from the past data, it helps the specific advertiser determine appropriate bidding prices that maximize the chance of winning while fulfilling the campaign goals. Furthermore, it converts a bidding price expressed in terms of viewable time to one expressed in terms of a number of impressions, to match the terms of the advertising opportunities posted by the publishers. At block 412, the advertising control platform 108 submits a bid for the specific advertiser including the converted bidding price as well as relevant ads each with an embedded tag to the bid exchange market. If the bid wins, the measurements created by the tags would further contribute to the repository of past data for analysis.

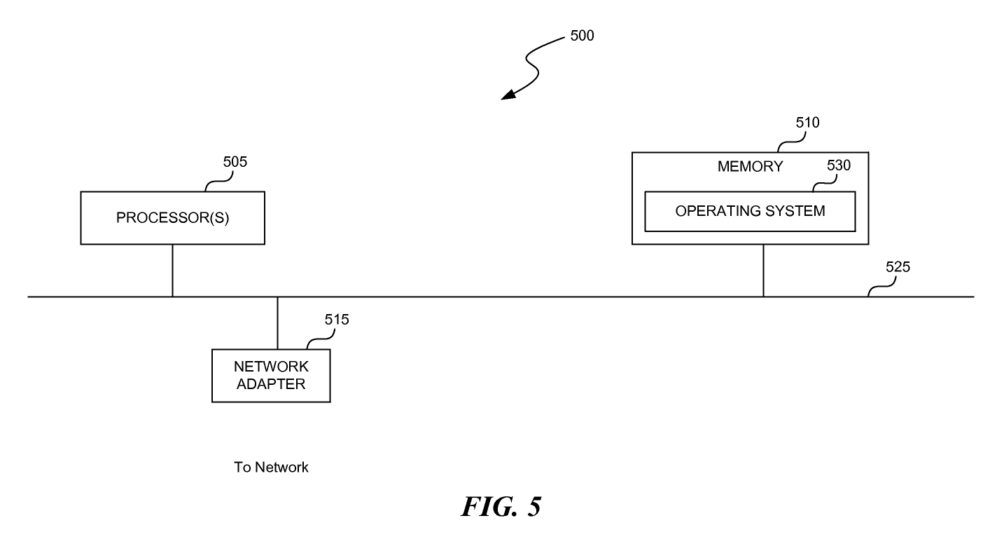

FIG. 5 is a high-level block diagram showing an example architecture of a computer, which may represent any electronic device, any server, or any node within a cloud service as described herein. The computer 500 includes one or more processors 510 and memory 520 coupled to an interconnect 530. The interconnect 530 shown in FIG. 5 is an abstraction that represents any one or more separate physical buses, point to point connections, or both connected by appropriate bridges, adapters, or controllers. The interconnect 530, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 510 is/are the central processing unit (CPU) of the computer 500 and, thus, control the overall operation of the computer 500. In certain embodiments, the processor(s) 510 accomplish this by executing software or firmware stored in memory 520. The processor(s) 510 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or the like, or a combination of such devices.

The memory 520 is or includes the main memory of the computer 500. The memory 520 represents any form of random access memory (RAM), read-only memory (ROM), flash memory, or the like, or a combination of such devices. In use, the memory 520 may contain code 570 containing instructions according to the techniques disclosed herein.

Also connected to the processor(s) 510 through the interconnect 530 are a network adapter 540 and a storage adapter 550. The network adapter 540 provides the computer 500 with the ability to communicate with remote devices over a network and may be, for example, an Ethernet adapter or Fibre Channel adapter. The network adapter 540 may also provide the computer 500 with the ability to communicate with other computers. The storage adapter 550 allows the computer 500 to access a persistent storage, and may be, for example, a Fibre Channel adapter or SCSI adapter.

The code 570 stored in memory 520 may be implemented as software and/or firmware to program the processor(s) 510 to carry out actions described above. In certain embodiments, such software or firmware may be initially provided to the computer 500 by downloading it from a remote system through the computer 500 (e.g., via network adapter 540).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

I/we claim:

1. A method performed by an advertisement control platform connected to an advertisement exchange market where publishers supply publication opportunities and advertisers bid for the publication opportunities, the method comprising:
embedding in an advertisement a computer program that produces data related to viewable time of the advertisement when the advertisement is published;
determining an analysis result based on data produced by the computer program for the advertisement;
determining a bidding price based on advertiser-supplied goals of the advertising campaign and the analysis result; and
submitting a bid to the advertisement exchange market in response to a publication opportunity.

2. The method of claim 1, wherein a publication opportunity is a spot within a publication of a publisher to be displayed to a type of audience during a timeframe.

3. The method of claim 1, wherein an advertisement is viewable when at least a certain percentage of the advertisement is visible in a screen and the window in which the advertisement is displayed is in focus.

4. The method of claim 1, wherein the computer program further creates advertisement data related to the advertisement and user data related to an audience of the advertisement.

5. The method of claim 1, wherein the data related to viewable time includes one or more of an amount of time the advertisement is viewable from each impression in a spot, an amount of time the advertisement is viewable during a period, and an amount of time the advertisement is placed in a spot.

6. The method of claim 1, wherein the minimum amount of viewable time refers to an amount of viewable time per impression or an amount of viewable time during a period.

7. The method of claim 1, wherein the goals of the advertising campaign further include a display frequency cap for the targeted audience.

8. The method of claim 1, wherein the goals of the advertising campaign include a selection of publishers and positions of spots within publications.

9. The method of claim 1, wherein the analysis result includes one or more of
(1) an average cost per impression during a period,
(2) an average viewable time from each impression during a period,
(3) an average length of an advertisement whose content changes over time,
(4) a relationship between bidding prices and probabilities of winning, and
(5) a distribution of a cost per view that is longer than a threshold over possible thresholds.

10. The method of claim 1, wherein the bidding price is determined periodically when a new publication opportunity becomes available, or when a condition of the advertisement exchange market changes.

11. The method of claim 1, wherein a bidding price expressed in terms of viewable time is a cost per second (CPS) or a cost per view (CPV), and a bidding price expressed in terms of impressions is a cost per impression (CPI) or a cost per thousand impressions (CPM).

12. A method comprising:
embedding tags to perform display-related measurements in advertisements to be submitted to an ad exchange market;
submitting bids on behalf of advertisers, each including a bidding price and an ad for publication, wherein the ads include embedded tags;
analyzing measurements from embedded tags from published ads previously submitted in bids;
receiving ad campaign goal data from a plurality of advertisers;
submitting bids priced based upon the analysis results and, for each advertiser, the respective ad campaign goal data received from that advertiser.

13. An advertising control platform comprising:
a measuring module for performing display-related measurements from embedded tags in advertisements;
an analysis module for determining pricing metrics based upon display-related measurements; and
a bidding module for creating advertising campaigns for advertiser customers according to advertiser-specified thresholds, wherein the bidding module places bids for advertising opportunities based the respective advertising campaigns at prices based upon the determined pricing metrics.
